(19) United States
(12) Patent Application Publication
(10) Pub. No.: US 2011/0114131 A1
(43) Pub. Date: May 19, 2011

(54) PROCESS VESSEL WITH APERTURED TUBE

(75) Inventor: Nelson Ying, Lake Buena Vista, FL (US)

(73) Assignee: GOOD EARTH POWER CORPORATION, Lake Buena Vista, FL (US)

(21) Appl. No.: 12/617,847

(22) Filed: Nov. 13, 2009

(51) Int. Cl. B01J 8/00; B08B 9/032

(52) U.S. Cl. 134/22.12; 422/187

(57) ABSTRACT

Provided are vessels having at least one tube with at least one aperture formed therein to input fluid, to extract fluid, or both, to or from the interior or exterior of the vessel. Such fluids may contain solid materials. The fluid may be exerted or expelled out of the at least one aperture so as to prevent formation of undesirable or collateral materials, such as ash or slag, or to reduce the formation or accumulation of such materials, or even to reduce or remove any collateral materials otherwise might be created and deposited within the process vessel. Fluid may also be extracted through one or more apertures. In other embodiments, one or more apertured tubes are disposed exterior to the process vessel so as to enable removal of material accumulating on the exterior of the vessel or application of material on the exterior of the vessel.

### TECHNICAL FIELD

The present application relates to the general field of industrial process equipment and to the field of chemical process vessels.

### BACKGROUND

Boilers, burners, and other process vessels are of great industrial importance and are useful in a variety of commercially important processes, including, for example, gasification, steam generation, heating, and the like.

While existing process vessels are manufactured of materials capable of withstanding the extreme conditions typically present in industrial processes, process vessels are nonetheless prone to the creation of collateral material such as, for example, ash, slag, or other material that may be evolved during gasification or other high-temperature processes. Such materials may foul or impair the system and can lead to reduced operating efficiency. Moreover, process vessels that are prone to the creation of such materials must occasionally be taken out of service for cleaning, reducing their overall efficiency.

### SUMMARY

Applicant discloses a process vessel comprising a tube with at least one aperture formed therein. A material such as, for example, a fluid may be passed through the tube and exerted or expelled out of the at least one aperture so as to prevent, reduce, and/or remove any collateral materials that otherwise might be created and deposited within the process vessel. The aperture may be suitably adapted to achieve the desired fluid transmission in each particular case. The fluid is suitably a gas or liquid, and may include solids, fine solids, radioactive particles, atomic particles (alpha particles, electrons, neutrons, protons), photons, phonons, and the like. For example, a fluid exerted through the at least one aperture may operate to prevent, reduce, and/or remove ash, slag, ash precursor, or slag precursor that has a tendency to develop within the process vessel. The fluid may prevent, reduce, and/or remove other undesired reactions or results within the process vessel, and may also operate to promote desired reactions or results within the process vessel.

Fluids or other materials may also be extracted from the process vessel via such apertured tubes in order to prevent material accumulation, reduce or eliminate undesired reactions or results within the process vessel, and/or also promote desired reactions or results within the process vessel. The apertured tubes may also be used to extract and obtain product material from the process vessel.

Material such as a fluid may be exerted through the at least one aperture of the tube during normal operation of the process vessel, e.g., while a reaction or other process is ongoing in the process vessel, such as a chemical reaction, combustion, drying, and the like. In one illustrative embodiment, material exerted through the at least one aperture is inert relative to any reaction ongoing in the process vessel. In other embodiments, the material exerted through the at least one aperture is selected to affect the reaction that is ongoing in the reaction vessel. The type of material introduced to the reaction chamber via the at least one aperture, the amount of material, and the timing and frequency of the insertion of materials are controlled as necessary to suit the particular reaction vessel and the requirements of any reaction ongoing in the vessel.

According to another aspect of the disclosed embodiments, the at least one aperture formed in the tube of the process vessel may be adapted to receive material from the area of the process vessel surrounding the tube. For example, in an illustrative embodiment, material that tends to form in the reaction vessel such as, for example, ash or slag, may be received at the at least one aperture and removed via the tube. In a potential embodiment, vacuum or suction may be applied at the at least one aperture in order to facilitate the removal of material via the at least one aperture.

In an illustrative embodiment, the at least one aperture formed in the tube of the process vessel may be adapted to both exert a fluid or other material into the process vessel as well as to receive material that is being expelled from the process vessel. In an exemplary embodiment, an aperture may alternate between exerting a material such as a fluid therethrough and receiving material into the aperture. In an exemplary embodiment, particular apertures may be devoted to exerting material into the vessel while other apertures may be devoted to receiving material that is being expelled from the process vessel.

In another aspect, the disclosed embodiments provide methods of operating a process vessel. These methods suitably include providing a process vessel comprising at least one tube disposed exterior to the process vessel, with the at least one tube comprising one or more apertures along the length of the tube. The user then exerts a fluid through at least one aperture of the tube so as to dislodge ash, slag, ash precursor, slag precursor, or other material disposed atop the process vessel.

Alternative process units are also disclosed. Such units suitably include a process vessel adapted to have a chemical reaction performed therein. The units also include one or more tubes positioned exterior to the process vessel, each of the one or more tubes comprising one or more apertures adapted to exert a fluid against the exterior of the process vessel so as to cleanse the exterior of the process vessel while a reaction is performed in the vessel.

Also provided are further process units, such units including a process vessel adapted to have a chemical reaction performed therein, and one or more tubes positioned in the process vessel, each of the one or more tubes comprising a material resistant to the attachment of ash, slag, ash precursor, slag precursor, or any combination thereof.

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter. Other features are described below.

### BRIEF DESCRIPTION OF THE DRAWINGS

The summary, as well as the following detailed description, is further understood when read in conjunction with the appended drawings. For the purpose of illustrating the potential embodiments, there are shown in the drawings various exemplary embodiments; however, the potential embodiments are not limited to the specific methods, compositions, and devices disclosed. In addition, the drawings are not necessarily drawn to scale. In the drawings:

FIG. 1 depicts a non-limiting exemplary embodiment comprising straight, apertured tubes;

FIG. 2 depicts a non-limiting exemplary embodiment comprising apertured tubes that spread from a single inlet tube;

FIG. 3 depicts a non-limiting exemplary embodiment comprising apertured tubes having apertured tubes extending therefrom;

FIG. 4 depicts an axial view of an exemplary embodiment;

FIG. 5 depicts a non-limiting exemplary embodiment comprising a helical apertured tube; and

FIG. 6 depicts a non-limiting exemplary embodiment comprising an apertured tube with apertured stages.

### DETAILED DESCRIPTION OF ILLUSTRATIVE EMBODIMENTS

### Overview

A process vessel according to the present embodiments suitably comprises at least one tube therein, with the at least one tube including one or more apertures along the length of the tube. A fluid is exerted through at least one aperture of the tube while operating a process within the process vessel, the fluid preventing the accumulation of and/or dislodging previously accumulated ash, slag, ash precursor, or slag precursor disposed within the process vessel.

At least a portion of the dislodged ash, slag, ash precursor, or slag precursor may be collected at one or more apertures formed in the tube comprised in the process vessel. For example, the collection may be accomplished by trapping the dislodged material in a grating, a filter (e.g., bag house filter), an electrostatic precipitator, a cyclone separator, or other collector, or by other suitable collection methods known to those of skill in the art. A vacuum may be applied at the aperture formed in the tube (or applied at the tube itself) so as to draw dislodged material (ash, slag, waste, etc.) into the tube or aperture for collection and disposal. Material may also be removed via an outlet in the process vessel. An absorbent may also be provided at the aperture, or at the tube, or elsewhere within the system to collect material from the process vessel.

In an exemplary embodiment, a fluid may be exerted (e.g., by positive pressure) through an aperture in the tube so as to dislodge or stir up ash or slag disposed within the reactor. A vacuum is then applied to the same or different apertured tubes so as to collect the dislodged material and to remove that material from the interior of the process vessel. In some embodiments, particular tubes are used to apply pressure to dislodge ash and slag while other tubes are used to collect the dislodged material. The dislodging and collection can be performed in an alternating or periodic fashion or, depending on process conditions, simultaneously. An alternating cycle of exerting a fluid and then applying a vacuum may be used to dislodge material disposed within the process vessel. Fluid exertion, withdrawal, or both, thus enables active prevention, minimization, or reduction of material buildup within the process vessel.

More than one fluid may be exerted through the apertures as needed depending upon the particular vessel, the ongoing reaction, and the desired result. For example, a fluid containing an agent (e.g., an acid or a base) that chemically degrades, breaks up, or otherwise loosens slag, ash, or related precursors may be applied. Thereafter, an additional fluid, such as, for example, nitrogen or other inert gas, may be exerted, with the effect of dislodging the loosened ash or slag deposits for collection. The particular fluid that is used may be selected for the desired characteristics relative to the ongoing reaction including, for example, the lack of reactivity (or minimal reactivity) with the processes ongoing in the process vessel. Multiple fluids may be exerted in sequence, or simultaneously, depending on the characteristics of the particular process vessel and industrial process being addressed. Fluid may be introduced (or withdrawn) from the vessel in a pulsatile or other rhythmic fashion, to aid in dislodging and collecting material from the interior of the process vessel.

In another potential embodiment, the fluid exerted into the process vessel may be selected for purposes of participating in a reaction that is occurring in the process vessel. In other words, the apertures formed in the at least one tube of the process vessel offer a methodology for inputting reactants into a process vessel. Material exerted into the process vessel may participate in an ongoing reaction, and may additionally operate to prevent, reduce, or remove accumulated deposits such as ash and slag as described herein. As one example, a fluid containing a material that retards the formation of ash or slag may be exerted into the interior of a process vessel. In another example, a material that encourages agglomeration of ash or slag may be exerted into the interior of the process vessel so as to cause any free-floating ash or slag to coalesce into deposits that may be removed from the process vessel.

The exerted fluid may be at ambient temperature, but may also be heated or cooled before introduction to the process vessel, depending upon the requirements of the particular application. Where a comparatively cool fluid may be of use in connection with the ongoing chemical process and/or dislodging and cleansing the ash and slag, the fluid may be cooled before introduction to the process vessel. In other embodiments, the fluid may be heated before introduction to the process vessel so as to be compatible with the ongoing chemical process and/or with infiltrating ash or slag deposits within the process vessel. The fluid may be heated to about 25° C., about 50° C., about 100° C., about 150° C., about 500° C., about 1000° C., or even hotter, depending on the user's needs.

Fluids may be exerted through apertures in an apertured tube so as to stir-up unwanted materials in a process vessel, and materials may be collected at apertures formed in a tube while the process vessel has a reaction ongoing therein. In this way, the disclosed systems and methods may reduce system downtime. Fluids may also be exerted and materials collected at apertures while the process vessel is off-line, which may enable a more vigorous cleansing than would be possible while the process vessel is operating.

A process vessel may be any type of structure that is adapted to have a chemical reaction performed therein. For example, boilers, burners, combustors, gasifiers, heat exchangers, kilns, reactors, and the like are all suitable process vessels. In an exemplary embodiment, process vessels (and associated apertured tubes) may be constructed, for example, from steel, wrought iron, cement, quartz, and the like.

Vessels and tubes may also be constructed of ceramic or composite materials, where desirable. A non-exclusive listing of such materials includes alloys (e.g., Haynes 230™), and the like. Non-transparent metal alloys can be used, with such materials suitably reaching reactor wall temperatures and suitably having high radiant emissivities. Glasses capable of withstanding high temperatures are considered suitable.

In some embodiments, the tube material is selected on the basis of its ability to resist attachment thereto by ash, slag, or other materials that evolve during operation of the process vessel. In these embodiments, the tube may be disposed so as to essentially line or hug the inner surface of the process vessel, so as to reduce the accretion of such materials on the inner surface of the process vessel. These tubes thus passively reduce accumulation of these materials. Fused quartz and ceramics are suitable tube materials for such embodiments, as are other materials known in the art to which ash, slag, and the like do not readily attach. Passive reduction and active reduction tubes may be used together in a particle system or process vessel. Tubes may be disposed within and exterior to a process vessel, depending on the user's needs.

Tubes according to the disclosed embodiments may also, in some embodiments, be disposed along the outer surface of a process vessel. These embodiments are useful, for example, in environments where material accumulates along the outer surface of the process vessel. Tubes made of material that resists accumulation of material produced within the process vessel are particularly suitable for these embodiments. The tube apertures may be disposed in register with inlets and outlets of the process vessel, so as to limit deposition of material on the outer surface of the process vessel as well as on the vessel's inlets and outlets.

In still other embodiments, active tubes (i.e., tubes capable of having fluid exerted through one or more apertures) are disposed exterior to the process vessel. In these embodiments, fluid is exerted through one or more apertures of the tubes so as to loosen or even dislodge material residing on the exterior of the process vessel. The tubes may be disposed such that fluid exerted from their apertures addresses only a portion of the exterior of the process vessel. Alternatively, the tubes may be disposed such that fluid exerted from their apertures addresses essentially all of the exterior of the process vessel.

In one non-limiting example, a series of apertured tubes is arranged around a cylindrical process vessel such that the tubes form a ring that is coaxial with the cylindrical process vessel. Fluid is then exerted through the apertures of the tubes so as to displace material that may accumulate on the exterior of the process vessel or even to prevent the accumulation of such materials. The fluid may be continuously delivered or pulsed, depending on the needs of the user and on process or environmental conditions. The fluid may, in some embodiments, be used to heat or cool the exterior of the process vessel. This may be useful, e.g., where the process vessel has become hot and the user desires to reduce the exterior temperature of the vessel.

The process vessel is suitably adapted to have a chemical reaction performed therein. The apertured tube or tubes are suitably positioned exterior to the process vessel, each of which suitably includes one or more tubes having one or more apertures adapted to exert a fluid against the exterior of the process vessel. The fluid, as described elsewhere herein, suitably cleanses the exterior of the process vessel while a reaction is performed in the vessel. The tubes are suitably of a material or materials essentially resistant to accumulation of ash, slag, ash precursor, slag precursor, and the like. In some embodiments, one or more tubes surmounts a portion of the process vessel and acts as a jacket or skin to the vessel. As described elsewhere herein, one or more of the tube apertures may be disposed in register with an inlet of the process vessel, an outlet of the process vessel, or any combination thereof.

The presently disclosed embodiments thus provides methods of operating a process vessel. These methods suitably include providing a process vessel (described elsewhere herein) that includes at least one tube disposed exterior to the process vessel. The tube suitably includes, as described elsewhere herein, one or more apertures along the length of the tube. The operator then exerts a fluid through at least one aperture of the tube so as to dislodge ash, slag, ash precursor, slag precursor, or other material disposed atop the process vessel. As is known in the art, process vessels are often operated in unforgiving conditions, and buildup of undesirable materials on the exterior of the vessel can impair the vessel's performance as well as pose a safety hazard. The exertion of the fluid is suitably performed during the process vessel's operation, but can also be perfomed when the vessel is off-line.

The process vessel may be of essentially any shape, size, or cross-section, and may be irregular in size. Tubular, cylindrical, and spherical process vessels are all considered suitable for use with the disclosed embodiments.

Virtually any combination of materials suitable for the intended purpose of the process vessel may be employed. For example, the vessel may include an inner layer or jacket of a material that is different from the material of the vessel's shell. In embodiments where radiation is used within the process vessel (e.g., radioactivity-driven reactions), the material of the tubes is suitably chosen so as to avoid impeding such radiation.

The process units also suitably include a source of pressurized fluid in fluid communication with one or more tubes. The source of pressurized fluid may be, for example, a pressurized tank or canister, or may be a non-pressurized reservoir connected to a pump or turbine. The fluid source is suitably in fluid communication with the one or more tubes that extend into the process vessel. Suitable fluids include, e.g., liquids, air, steam, carbon dioxide, flue gas, nitrogen, vitiated air, and the like. Particles, radioactive materials, and the like may be present in the fluids. Alpha particles, electrons, neutrons, protons, phonons, and photons (of virtually any wavelength) are all suitably introduced via a tube.

In some embodiments, the process vessel may comprise a vacuum source (or other pressure gradient) in fluid communication with one or more tubes. The vacuum source may also be in communication with the process vessel. As one non-limiting example, the vacuum source is coupled directly to the process vessel so as to draw out of the process vessel any ash or slag that may be dislodged or freed by action of fluid exerted into the process vessel by the apertured tubes.

The apertured tubes may be formed from any material that is suitable for inserting fluid and materials into the process vessel and which is capable of withstanding the conditions within the process vessel. Such materials may include, for example, steel, quartz, ceramics, and the like. In an exemplary embodiment, the tubes may be formed from a material that is essentially inert to the chemical species present in the process vessel, so as to avoid any unintentional interference with any processes ongoing inside the process vessel. The tubes may be further formed from a material that is transparent to radiant heat (or other radiation, including light), such as quartz. This may be useful where the radiation is used to promote or otherwise affect a reaction within the process vessel. In some embodiments, the tube or tubes disposed within the process vessel may reflect heat back to their surroundings.

The tubes may have any configuration and/or shape that is suitable to arrive at the desired result. For example, a tube may have a circular cross-section, but may also be oval, polygonal, or have essentially any other cross-section. The tubes may be curved, straight, elongate, or even helical, as shown in the attached figures. The shape or cross-sectional profile of a particular tube or set of tubes may vary along part of or the entirety of the tube length. For example, a tube may include one or more bulges, kinks, or curves along its length. A process vessel or system may include two or more identical tubes, or may include tubes that are different from one another in size, shape, material, or other aspect.

### Exemplary Embodiments

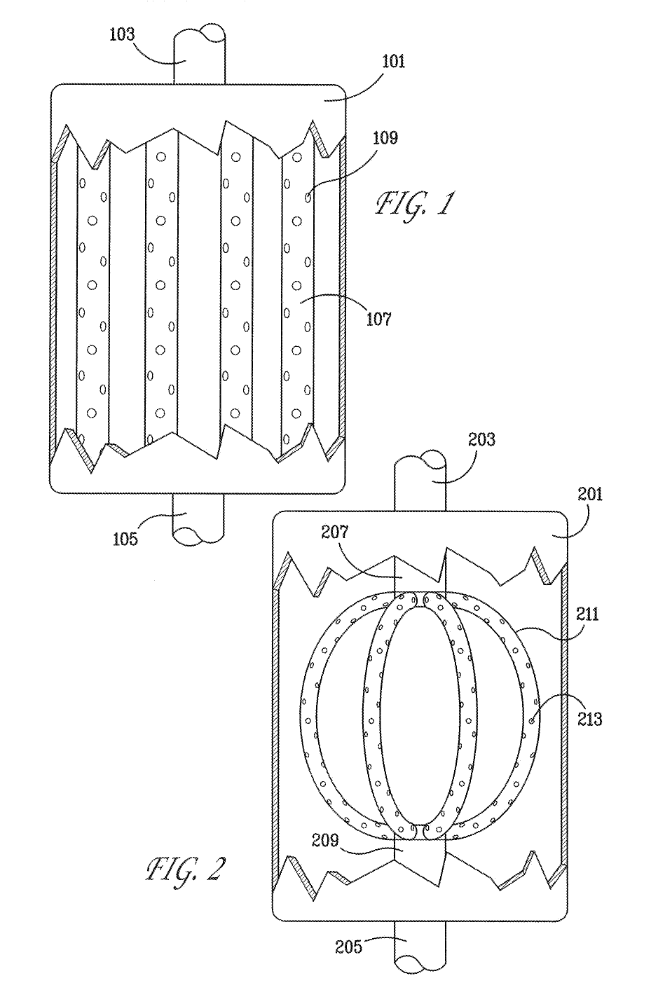

FIG. 1 depicts a non-limiting exemplary embodiment of process vessel 101. Process vessel 101 is shown partially in section so as to depict tubes 107 formed therein in a combustion or reaction chamber of the vessel 101. In the exemplary embodiment of FIG. 1, process vessel 101 comprises multiple, straight apertured tubes 107 disposed within. Each of tubes 107 comprises a plurality of apertures 109 along the length of the tube. Tubes 107 and apertures 109 may be formed in any configuration so as to direct the exerted fluid at the desired location within vessel 101. For example, in the illustrative embodiment of FIG. 1, at least some of the apertures 109 of the tubes may be directed toward the inner surface or surfaces of process vessel 101 such that fluid exerted through the apertures impacts the inner surface or inner surfaces of the process vessel. Two or more tubes 107—whether straight or of another configuration—may be in fluid communication with one another or be fluidically separate from one another. As one non-limiting example, two apertured tubes 107 may be connected by a bridging tube or conduit.

In an exemplary embodiment, process vessel 101 comprises inlet 103 and outlet 105. Inlet 103 may be adapted to receive material for communication into process vessel 101. For example, inlet 103 may receive and communicate material for processing in vessel 101. In an exemplary scenario, inlet 103 may receive a carbonaceous feed for use in a reaction that is ongoing in vessel 101. Inlet 103 may additionally or alternatively be in communication with one or more of tubes 107 located in vessel 101. In an exemplary embodiment, one of more of apertured tubes 107 is fluidly coupled with inlet 103 or a similar inlet for receiving fluid that is exerted through tubes 107 and its associated apertures 109. In some embodiments, a manifold or other distributor, which may be comprised, for example, in inlet 103, distributes fluid to one or more apertured tubes 107 for exertion into the process vessel. In an alternative embodiment, one or more of the apertured tubes 107 may have a dedicated inlet 103 to supply fluid.

In an exemplary embodiment outlet 105 is fluidly coupled to receive the outflow from a reaction ongoing in vessel 101. In an exemplary scenario, outlet 105 may receive the result of the combustion of carbonaceous material in vessel 101. Inlet 103 and/or outlet 105 may additionally or alternatively be fluidly coupled with tubes 107 so as to receive any materials that may be passing through tubes 107. In an exemplary scenario, outlet 105 may receive residual gas that is passing through a particular tube 107. In a scenario wherein a particular tube 107 is adapted to receive materials such as ash, soot, and/or carbon dioxide from the inside of vessel 101, outlet 105 may receive any such materials that are being vacated by fluid expressed by the apertured tube. In some embodiments (not shown), one or more apertures of the tube is in register with an aperture or other opening of the process vessel.

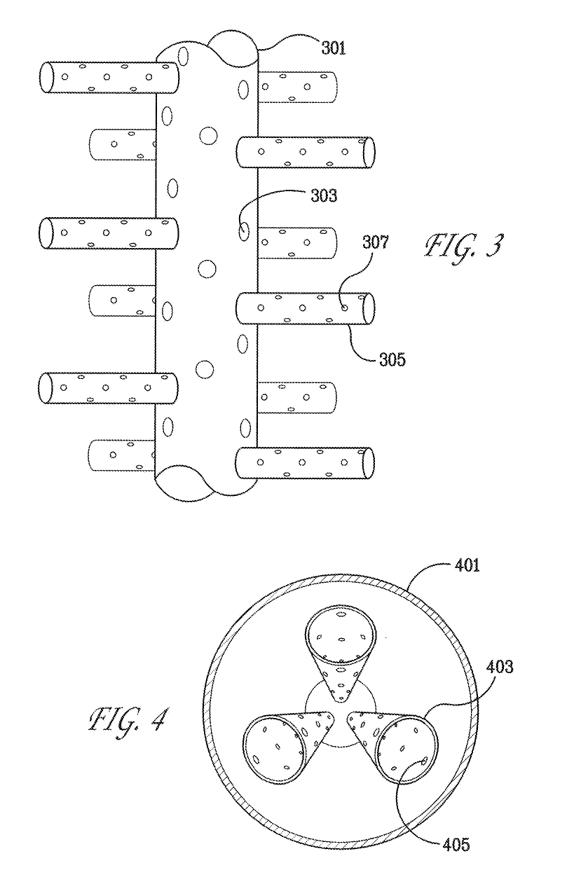

FIG. 2 provides a view of another exemplary configuration of apertured tubes in a process vessel. As shown, process vessel 201 comprises inlet 203 and outlet 205 similar to that described above in connection with FIG. 1 to introduce and remove fluid or feed from process vessel 201. Process vessel 201 further comprises multiple tubes 211 that branch from a distributor tube 207 or manifold. Each of tubes 211 includes an aperture 213 for exerting fluid into and/or for receiving material from the reaction ongoing in vessel 201. Distributor tube 207 may itself include apertures (not shown in this figure). In an embodiment such as depicted in FIG. 2 comprising a distributor tube 207, fluid is supplied into the central trunk tube, which fluid is then distributed to tubes 211. Fluid is exerted through apertures 213 and directed to the interior of vessel 201. Tubes 211 may be of the same size as one another, or may be of different sizes. The branch tubes may then reunify into a single outlet tube 209, or, in alternative embodiments, the branch tubes may unify into multiple outlet tubes.

FIG. 3 provides a detailed view of apertured tube 301 that may be suitable for use in exemplary embodiments such as, for example, those depicted in FIGS. 1 and 2. As shown, tube 301 has one or more hollow conduits 305 (also known as “lances”) projecting outward from tube 301. Tube 301 and conduits 305 have apertures 303 and 307 formed therein, respectively. Fluid that flows through tube 301 also flows through one or more lances 305 and is exerted through apertures 307 as well as apertures 303. In an embodiment such as depicted in FIG. 3, fluid exerted through a tube 301 can be directed into three dimensions by the apertured hollow conduits 305 extending from that tube. The tube 301 includes apertures 303, although such apertures are not required. Likewise, conduits 305 are shown with apertures 307, but such apertures are not required, as fluid and/or other materials may be exerted through or taken up by the ends of the conduits 305. While FIG. 3 illustrates conduits 305 projecting perpendicular from the tube 301, perpendicular orientation is not required. The orientation of the lance or conduit relative to the tube will depend on the optimal angle for obtaining the desired results. Additionally, while the walls of the process vessel are not shown in relationship to the placement and angles of the conduits 305 in FIG. 3, it is not necessary that the conduits 305 be perpendicular to the process vessel wall, and the angle of the conduits relative to the process vessel wall will depend on the optimal angle for obtaining the desired results.

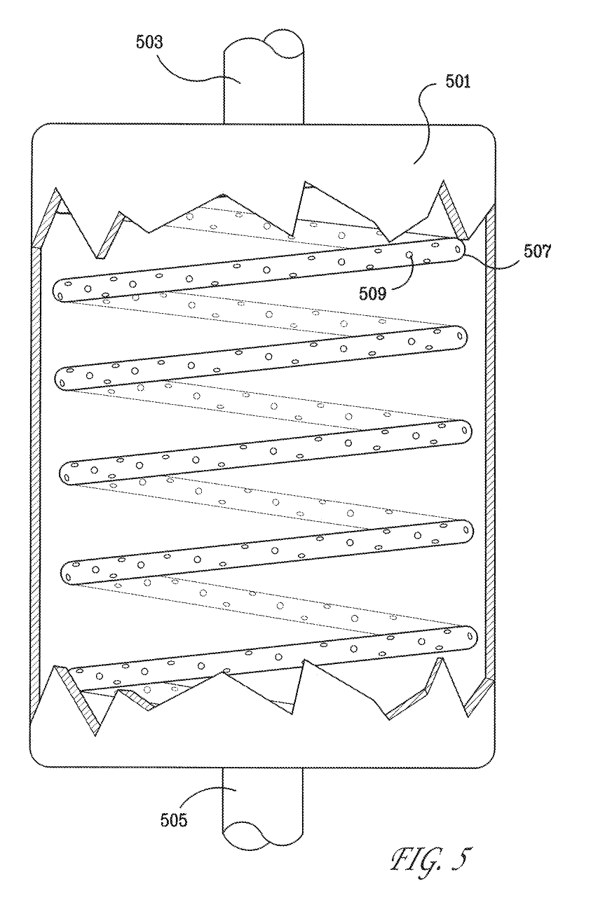

FIG. 4 provides a sectional axial view of an exemplary process vessel 401. FIG. 4 presents a view looking along the length of apertured tubes 403 which extend along the length of process vessel 401. Each of tubes 403 comprises apertures 405 formed therein. As shown, a portion of tubes 403 faces an interior wall of vessel 401. Fluid exerted through tube 403 and through apertures 405 may be directed at the interior wall so as to remove material such as soot and slag from the interior wall. A portion of each of tubes 403 faces an opposing tube 403. Fluid flowing through tube 403 and exerted through apertures is directed at the exterior wall of the opposing tube 403 so as to remove material such as soot and slag from the opposing tube 403. In this way, the tubes 403 can clean one another. While not shown in this figure, the tubes 403 may be of non-uniform cross-sectional dimension and shape along their length. For example, a tube may be comparatively narrow at its inlet, broader along its length, and narrow at the outlet. Tubes may, as described elsewhere herein, be circular, triangular, square, ovoid, or polygonal in cross-section.

FIG. 5 depicts another exemplary embodiment of a process vessel. As shown in FIG. 5, a helical tube 507 is disposed within a process vessel 501 which is shown partially in section. Tube 507 has apertures 509 disposed so as to exert fluid against the interior surface of the process vessel 501. A helical, apertured tube such as is shown enables the user to address, with fluid exerted from a single tube, essentially the entirety of the interior surface area of the process vessel. Helical tube 507 may be tightly wound such that each circumferential loop of the tube is comparatively close to neighboring loops. Alternatively, helical tube 507 may be more widely wound such that each circumferential loop is spaced at a distance from neighboring loops. Helical tube 507 may comprise any number of circumferential loops. For example, helical tube 507 may include only a single circumferential loop. In other embodiments, helical tube 507 may comprise 2, 3, 5, or even 10 loops. The optimal number of loops will be determined by the dimensions of the process vessel and by the desired outcome. Process vessel 501 may include inlets 503 and outlets 505 for introduction of feed or fluid to the vessel and removal of materials from the vessel as discussed above in connection with FIG. 1.

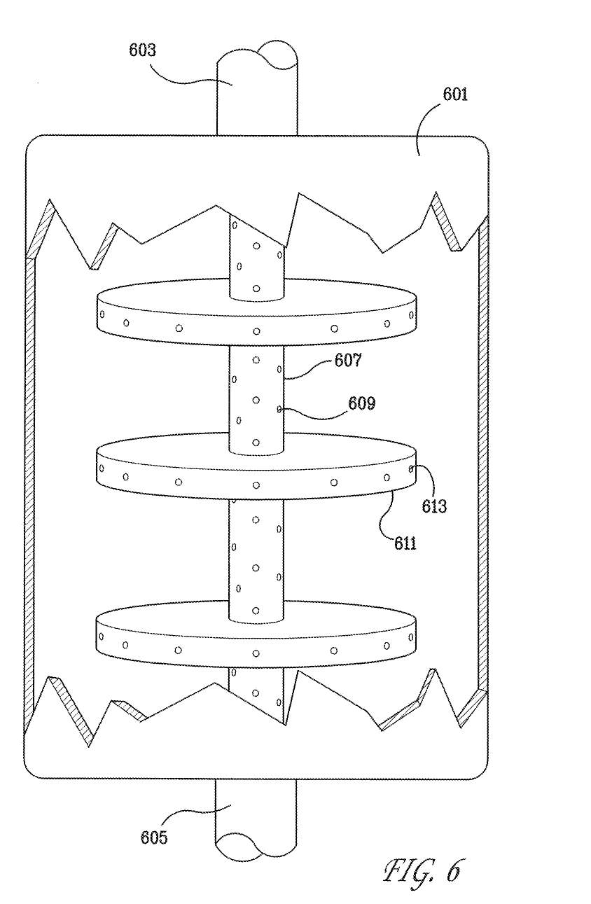

FIG. 6 depicts another exemplary embodiment of a process vessel having apertured tubes therein. In the embodiment illustrated in FIG. 6, a central trunk tube 607 feeds fluid to apertured stages 611 that are located along the length of trunk tube 607. Trunk 607 and stages 611 have apertures 609 and 613 formed therein respectively for exerting fluid into the combustion chamber of vessel 601 and for receiving and removing unwanted materials from the vessel 601. Fluid conveyed along the length of trunk tube 607 is distributed to perforated stages 611. The fluid is exerted or ejected through apertures 613 toward the inner walls of process vessel 601. In the embodiment disclosed in FIG. 6, apertures 613 are positioned comparatively closely to the inner walls of the process vessel 601 as compared with trunk tube 607. In the exemplary embodiment of FIG. 6, stages 611 have a circular perimeter, i.e. are disc shaped, which corresponds to the inner surface of vessel 601. It should be appreciated that stages 611 may have any shape suitable for the particular application including, for example, spherical, ovoid, polygonal, or other shapes. Inlet 603 and outlet 605 are adapted to introduce feed or fluid to the process vessel and remove material from the process vessel as described above in connection with FIG. 1. The apertures on the stages 611 need not be disposed at the edges of the stages. Apertures on the stages 611 may be disposed on the upper or lower surfaces of the stages. The stages 611 may have rounded edges, and apertures may be disposed on these edges (not shown in this figure).

Process vessels consistent with the disclosed embodiments may be of virtually any size or shape. For example, process vessels may be from about 0.1 m³ up to about 100 m³ or even to about 1000 m³ in volume. Such vessels may be from about 0.1 m in length up to about 100 m in length. In an exemplary embodiment, the vessels may be from about 1 m to about 10 m in length. The vessels may also suitably be from about 0.1 m to about 100 m in width, or even from about 0.1 to about 1 m in width. In the embodiments depicted in the Figures, the process vessels have circular cross sections. However, the potential embodiments may have any shape including, for example, ovoid or polygonal in cross-section. The process vessels may be spherical or elongate in shape.

In some embodiments, the process vessels and apertured tubes are constructed so as to be easily disassembled from one another. As one non-limiting example, the process vessel in FIG. 6 may be constructed such that the trunk tube 607 and stages 611 may be lifted out of the process vessel. Similarly, the vessel shown in FIG. 5 may be constructed such that the helical apertured tube 507 may be lifted out of the process vessel.

Apertured tubes consistent with the disclosed embodiments may have essentially any shape, configuration, and size that is suitable for the particular application process vessel in which they are applied. For example, the cross sectional shape of the tubes may be circular, oval, rectangular, triangular or any other shape. Furthermore, the cross-sectional shapes of the tubes in any one process vessel may vary as necessary in order to achieve the desired effect. Similarly, the lengthwise profile of the tubes may be any that is suitable. For example, the tubes in a process vessel may be straight and parallel, circular and intertwined, or any other configuration necessary to achieve the desired effect.

The cross sectional diameter and the length of the tubes may vary according to the desired result and the size and configuration of the corresponding process vessel. For example, apertured tubes may have a cross section diameter of between about 0.0001 m to 1 m. In an embodiment such as depicted in FIG. 3 wherein conduits extend from an apertured tube, the conduit may have any size that is suitable for the particular application. For example, a conduit may be of a length that is from about 0.0001 to about 0.1 or even about 0.2 times the length of the tube from which the conduit projects. In some embodiments, the conduit has a length that is in the range of from about 0.001 to about 0.05 times the length of the tube from which the conduit projects or even from about 0.01 to about 0.05 times the length of the tube.

The apertures formed in tubes and conduits consistent with the disclosed embodiments may be any size, shape, and distribution suitable for exerting fluid and receiving slag, ash, or other material from a process vessel. For example, apertures may be circular in cross section and have a diameter from about 0.1 mm to about 1 m in diameter or other cross-sectional dimension. In another embodiment, the apertures may be from about 1 cm to about 10 cm in diameter or other cross-sectional dimension. The apertures might alternatively be triangular, square, oval, polygonal, or any other shape that is suitable for the desired effect. Apertures of varying size and shape may be used on a single tube or within a single vessel. Furthermore, apertures may be disposed in a regular or a random pattern along the length of a tube. For example, along the length of a single tube, apertures may be clustered on a first portion of the face of the tube that is proximate to an internal wall of the process vessel, as well as on a second portion of the tube that faces another tube within the process vessel.

Fluid throughput in the tubes may be controlled so as to satisfy the desired result for the particular process vessel. For example, fluid may be exerted from about atmospheric pressure up to about 100 psi, 500 psi, 1000 psi or even 5000 psi, depending on the user's needs. The fluid may be exerted in a continuous, pulsed, or other user-set manner. Fluid may be expelled through the apertures and then, after ash, slag, or other undesirable material is entrained in the fluid, the fluid may be drawn back into the apertured tubes or otherwise removed from the vessel.

The process vessels and tubes can be of virtually any relative dimension, and the optimal dimensions for each may be derived to meet the requirements of the particular application. In some embodiments, the ratio of a characteristic dimension (e.g., diameter, width, span) of at least one tube to the corresponding characteristic dimension of the process vessel is in the range of from about 0.01 to about 0.75. In other embodiments, the ratio is in the range of about 0.1 to about 0.3. For example, a cylindrical process vessel having a diameter of about 1 meter may be populated by one or more tubes having a diameter of about 0.1 meters. The apertured tubes disposed within a given process vessel need not all be the same size or have the same pattern of apertures.

In some embodiments, the ratios of the internal diameter of tube to the internal diameter of the process vessel in which the tube is positioned is from about 1:100 to about 1:5. In some embodiments, however, there may be a single inner tube, and in some embodiments, the diameter of the internal tube can be up to 90%, 95%, 99% or even 99.9% of the diameter of the outer process vessel. Having the apertures of the inner tube (or tubes) close to the inner surface of the process vessel can facilitate removal or dislodging of material evolved within the process vessel. In some embodiments, the tube is sized so as to hug or line at least a portion of the inner surface of the process vessel.

The tubes may be uniformly distributed within the process vessel. In other embodiments, the tubes may be randomly distributed within the vessel. The tubes and associates apertures may be, in some vessels, positioned such that essentially every point on the interior surface of the process vessel is impacted by fluid exerted from the apertured tubes. In other embodiments, tubes and apertures are positioned so as to focus or concentrate fluid flow at a particular area or areas within a process vessel.

In some embodiments, the apertured tubes of the disclosed embodiments may be integrated into existing process vessels. This is suitably accomplished, for example, by forming the tubes as a modular unit assemble that is inserted into existing process vessels. In other embodiments, the cleansing tubes are integrated into the process vessel during the vessel's manufacture.

There are numerous potential applications for product vessels consistent with the disclosed embodiments. For example, a process vessel with apertured tubes consistent with the disclosed embodiments may be embodied in a gasifier device used to gasify coal or other carbonaceous material. A gasifier may include a vessel in which the carbonaceous material (e.g., coal or coal slurry) is heated to form char and volatile products. The carbonaceous char is then reacted with water to form hydrogen and carbon monoxide. Both of these processes evolve ash and slag, which can accumulate and impair the performance of the process vessel. Apertured tubes may extend into the gasifier vessel and exert a fluid such as, for example, air, nitrogen and/or recycled flue gas, into the vessel so as to dislodge the ash and slag. The dislodged material can be blown out of the vessel via an outlet and/or collected at apertures formed in particular tubes positioned in the vessel. As described elsewhere herein, a vacuum or other gradient is suitably applied to facilitate removal of dislodged material.

Thus, Applicant has disclosed, inter alia, a process vessel including a tube with at least one aperture formed along the length of the vessel to selectively input and/or to selectively extract fluid. The fluid may be a liquid or a gas, and may, without limitation, contain solids, radioactive particles, atomic particles, and the like. A material such as, for example, a fluid may be passed through the tube and exerted or expelled out of the at least one aperture so as to prevent, reduce, and/or remove any collateral materials that otherwise might be created and deposited within the process vessel; and/or to prevent, reduce, and/or remove other undesired reactions or results within the process vessel; and/or as may operate to promote desired reactions or results within the process vessel. For example, a fluid exerted through the at least one aperture may operate to prevent, reduce, and/or remove ash, slag, ash precursor, or slag precursor that has a tendency to develop within the process vessel. Fluid or other materials may also be selectively extracted from the process vessel via such apertured tubes in order to prevent, reduce or remove undesired reactions or results within the process vessel; and/or to promote desired reactions or results within the process vessel; and/or to extract and obtain product material. The size and orientation of the apertures may be suitably optimized for the user's needs in a given application. For example, the apertures in a given tube may all be of the same size and shape. In other embodiments, two or more of the apertures in a tube are of different sizes and shapes. Tubes may also, as described elsewhere herein be disposed exterior to the process vessel.

The potential embodiments are not limited to the specific devices, methods, applications, conditions or parameters described and/or shown herein, and that the terminology used herein is for the purpose of describing particular embodiments by way of example only and is not intended to be limiting. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

Features of the potential embodiments which are, for clarity, described herein in the context of separate embodiments, may also be provided in combination in a single embodiment. Conversely, various features of the potential embodiments that are, for brevity, described in the context of a single embodiment, may also be provided separately or in any subcombination. Further, reference to values stated in ranges include each and every value within that range.

What is claimed:

1. A method of operating a process vessel, comprising:
providing a process vessel comprising at least one tube therein, the at least one tube comprising one or more apertures along the length of the tube;
exerting a fluid through at least one aperture of the tube while operating a process within the process vessel, the fluid dislodging ash, slag, ash precursor, slag precursor, or other material disposed within the process vessel.

2. The method of claim 1, further comprising collecting at least a portion of the dislodged ash, slag, ash precursor, or slag precursor.

3. The method of claim 1, wherein the collecting at least a portion of the dislodged ash, slag, ash precursor, or slag precursor or other material comprises collecting at least a portion of the dislodged ash, slag, ash precursor, or slag precursor or other material at an aperture formed in a tube disposed in the process vessel.

4. The method of claim 3, wherein collecting at least a portion of the dislodged ash, slag, ash precursor, or slag precursor at an aperture formed in a tube comprises applying a pressure gradient, an absorbent, or both, at the aperture formed in the tube.

5. The method of claim 1, wherein the exerting is performed continuously.

6. The method of claim 1, wherein the exerting is performed periodically.

7. The method of claim 1, further comprising exerting a material into the process vessel by way of one or more tubes.

8. The method of claim 7, wherein the exerting is accomplished by a tube comprising one or more apertures.

9. The method of claim 1, wherein exerting a fluid through at least one aperture of the tube comprises exerting a fluid that does not react with the process operating in the process vessel.

10. The method of claim 1, wherein exerting a fluid through at least one aperture of the tube comprises exerting a fluid that reacts with the process operating in the process vessel.

11. The method of claim 1, wherein the at least one tube is at least partially transparent to radiant heat.

12. A process unit, comprising:
a process vessel adapted to have a reaction performed therein; and
one or more tubes positioned in the process vessel, each of the one or more tubes comprising one or more apertures adapted to exert fluid into the process vessel to cleanse the interior surface of the process vessel while a reaction is performed in the vessel.

13. The process unit of claim 12, wherein the process vessel comprises a boiler, a burner, a combustor, or any combination thereof.

14. The process vessel of claim 12, further comprising a source of pressurized fluid in fluid communication with one or more tubes.

15. The process unit of claim 12, further comprising a fluid reservoir in fluid communication with one or more tubes.

16. The process unit of claim 12, further comprising a vacuum source in fluid communication with one or more tubes.

17. The process unit of claim 12, wherein one or more tubes comprises a material essentially transparent to radiant heat.

18. The process unit of claim 12, wherein one or more tubes comprises quartz.

19. The process unit of claim 12, wherein at least a portion of one or more tubes is circular in cross-section, oval in cross-section, polygonal in cross-section, or any combination thereof.

20. The process unit of claim 12, wherein one or more of the apertures faces the interior of the process vessel.

21. The process unit of claim 12, wherein one or more of the apertures faces away from the interior of the process vessel.

22. The process unit of claim 12, wherein at least a section of one or more tubes is characterized as elongate in configuration.

23. The process unit of claim 12, wherein at least a section of one or more tubes is characterized as curved in configuration.

24. The process unit of claim 12, wherein at least a section of one or more tubes is characterized as helical in configuration.

25. The process unit of claim 12, further comprising a heat source capable of providing heat to the interior of the process vessel.

26. The process unit of claim 12, wherein two or more tubes are disposed adjacent to an inner surface of the process vessel.

27. The process unit of claim 12, wherein at least one tube comprises one or more hollow conduits placing the interior of the tube in fluid communication with the interior of the process vessel.

28. The process unit of claim 12, wherein one or more hollow conduits comprise one or more apertures placing the conduit in fluid communication with the interior of the process vessel.

29. The process unit of claim 12, wherein the ratio of a characteristic dimension of at least one tube to the corresponding characteristic dimension of the process vessel is in the range of from about 0.05 to about 0.5.

30. The process unit of claim 29, wherein the ratio of a characteristic dimension of at least one tube to a corresponding characteristic dimension of the process vessel is in the range of from about 0.05 to about 0.3.

31. The process unit of claim 12, further comprising an inlet for a fuel and a fuel feed tube connected to this fuel inlet.

32. A method of operating a process vessel, comprising:
providing a process vessel comprising at least one tube disposed exterior to the process vessel,
the at least one tube comprising one or more apertures along the length of the tube;
exerting a fluid through at least one aperture of the tube so as to dislodge ash, slag, ash precursor, slag precursor, or other material disposed atop the process vessel.

33. The method of claim 32, wherein the exerting a fluid is performed during operation of the process vessel.

34. A process unit, comprising:
a process vessel adapted to have a reaction performed therein; and
one or more tubes positioned exterior to the process vessel, each of the one or more tubes comprising one or more apertures adapted to exert a fluid against the exterior of the process vessel so as to cleanse the exterior of the process vessel while a reaction is performed in the vessel.

35. The process unit of claim 34, wherein at least one tube comprises a material essentially resistant to accumulation of ash, slag, ash precursor, slag precursor, or any combination thereof.

36. The process unit of claim 34, wherein one or more tubes surmounts a portion of the process vessel.

37. The process unit of claim 34, wherein one or more tubes comprises an aperture in register with an inlet of the process vessel, an outlet of the process vessel, or any combination thereof.

38. A process unit, comprising:
a process vessel adapted to have a reaction performed therein; and
one or more tubes positioned in the process vessel, each of the one or more tubes comprising a material resistant to the attachment of ash, slag, ash precursor, slag precursor, or any combination thereof.

39. The process unit of claim 38, wherein one or more tubes is disposed so as to surmount at least a portion of the interior of the process vessel.

40. The process unit of claim 38, wherein one or more tubes comprises quartz, glass, or any combination thereof.
